(19) United States
(12) Patent Application Publication
(10) Pub. No.: US 2024/0125960 A1
(43) Pub. Date: Apr. 18, 2024

(54) SYSTEM AND METHOD FOR EVALUATING URBAN GROUND STABILITY USING TRAFFIC NOISE

(71) Applicant: KOREA INSTITUTE OF GEOSCIENCE AND MINERAL RESOURCES, Daejeon (KR)

(72) Inventors: Woohyun Son, Sejong-si (KR); Yunseok Choi, Seoul (KR); Seong Hyung Jang, Daejeon (KR); Donghoon Lee, Daejeon (KR)

(21) Appl. No.: 18/380,751

(22) Filed: Oct. 17, 2023

(30) Foreign Application Priority Data
Oct. 17, 2022 (KR) 10-2022-0132965

(51) Int. Cl. G01V 1/32; G01V 1/28; G01V 1/30

(52) U.S. Cl. CPC G01V 1/32; G01V 1/282; G01V 1/303; G01V 2210/42

(57) ABSTRACT

An object of the present invention is to provide a system and a method for evaluating an urban ground stability using traffic noise, which derive a physical property (S wave velocity) according to a depth by performing an inversion for a surface wave dispersion curve generated by traffic vibration in order to more accurately derive an underground physical property value (S wave velocity).

In order to achieve the object, a system for evaluating an urban ground stability using traffic noise according to the present invention includes: a signal measurement unit measuring a passive elastic wave signal generated by the traffic noise, and acquiring an elastic wave signal containing refracted waves using an artificial transmission source in an exploration area; and a server performing an inversion by applying a surface wave dispersion curve inversion technique to a frequency-phase velocity dispersion curve according to the passive elastic wave signal or the elastic wave signal containing the refracted wave.

### CROSS-REFERENCE TO RELATED APPLICATION

This application claims priority to Korean Patent Application No. 10-2022-0132965 filed on Oct. 17, 2022, and all the benefits accruing therefrom under 35 U.S.C. § 119, the contents of which is incorporated by reference in its entirety.

### BACKGROUND OF THE INVENTION

### 1. Field of the Invention

The present invention relates to a system and a method for evaluating an urban ground stability using traffic noise, and particularly, to a system and a method for evaluating an urban ground stability using traffic noise, which derive a physical property according to a depth by performing an inversion for a surface wave dispersion curve.

### 2. Description of the Related Art

Underground structure exploration is used to determine an underground structure and geological characteristics of a specific area and to find useful resources buried underground, especially oil.

As the use of underground resources increases, the underground structure exploration is being widely conducted not only on land but also in the sea.

A geological property required to determine the characteristics of the underground structures is the velocity of propagation of elastic waves in an underground medium.

In other words, in order to know the propagation velocity of the elastic waves in the underground medium in a desired area on land or in the sea, research is being conducted on a method of receiving and analyzing elastic waves reflected or refracted from the area to be measured.

According to this, sound waves, etc. are artificially projected to the relevant area, and then a predetermined calculation is performed using the elastic wave data reflected or refracted from this area to obtain the elastic wave propagation velocity in the underground medium.

In this way, a full waveform inversion method is used to determine the propagation velocity of the underground medium using elastic wave data.

Full waveform inversion is a method of finding a stratum velocity structure through repeated calculations using the elastic wave data.

In order to find a solution through the full waveform inversion, a velocity model must be repeatedly changed to minimize an objective function defined as the difference between the acquired data and the synthesized data, and many methodologies are provided to implement this.

Generally, the inversion is a process of deriving the solution to the objective function.

Conventional methods of performing the inversion include a local optimization technique and a global optimization technique.

However, the local optimization-based inversion technique has a problem in that if a range of an initial value of a variable to be derived is set to greatly deviate from an actual solution, the range converges to a local minima and an inaccurate solution is derived.

To overcome the local minima problem during such inversion, a global optimization-based inversion technique can be used.

However, since the global optimization-based inversion technique approximates a global optimal value using a probabilistic technique, there is a problem that the accuracy of the solution may decrease.

Therefore, it is necessary to develop a new inversion technique that increases the accuracy of the solution.

### SUMMARY OF THE INVENTION

In order to solve the problem in the related art, an object of the present invention is to provide a system and a method for evaluating an urban ground stability using traffic noise, which derive a physical property (S wave velocity) according to a depth by performing an inversion for a surface wave dispersion curve generated by traffic vibration in order to more accurately derive an underground physical property value (S wave velocity).

In order to achieve the object, a system for evaluating an urban ground stability using traffic noise according to the present invention includes: a signal measurement unit measuring a passive elastic wave signal generated by the traffic noise, and acquiring an elastic wave signal containing refracted waves using an artificial transmission source in an exploration area; and a server performing an inversion by applying a surface wave dispersion curve inversion technique to a frequency-phase velocity dispersion curve according to the passive elastic wave signal or the elastic wave signal containing the refracted wave.

Further, in the system for evaluating an urban ground stability using traffic noise according to the present invention, the server includes an artificial synthetic model generation unit generating a horizontal 2-layer S-wave velocity model which is an artificial synthesis model from the elastic wave signal containing the refracted wave by using a refraction method, a dispersion curve generation unit generating the frequency-phase velocity dispersion curve from the passive elastic wave signal or the S-wave velocity model, an inversion performing unit performing an inversion by applying a surface wave dispersion curve inversion technique to the generated frequency-phase velocity dispersion curve, and a verification unit verifying the accuracy of the surface wave dispersion curve inversion technique.

In addition, in the system for evaluating an urban ground stability using traffic noise according to the present invention, the dispersion curve generation unit generates a virtual common transmission source collection by applying the cross-coherence based seismic interferometry technique to the elastic wave signal including the passive elastic wave signal or the refracted wave.

In addition, in the system for evaluating an urban ground stability using traffic noise according to the present invention, the dispersion curve generation unit applies a phase-shift and stack technique to the generated virtual common transmission source collection to generate a frequency-phase velocity dispersion spectrum.

In addition, in the system for evaluating an urban ground stability using traffic noise according to the present invention, the dispersion curve generation unit generates a frequency-phase velocity dispersion curve for the inversion from the generated frequency-phase velocity dispersion spectrum through picking.

In addition, in the system for evaluating an urban ground stability using traffic noise according to the present invention, the verification unit compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

In addition, the system for evaluating an urban ground stability using traffic noise according to the present invention includes an analysis unit quantitatively analyzing the accuracy of the inversion, and the analysis unit derives a correlation between the first inversion value and the second inversion value.

Therefore, in the system for evaluating an urban ground stability using traffic noise according to the present invention, the surface wave dispersion curve inversion technique is a particle swarm optimization technique.

Meanwhile, in order to achieve the object, a method for evaluating invention includes: a first step of measuring, by a signal measurement unit, a passive elastic wave signal generated by the traffic noise, and acquiring an elastic wave signal containing refracted waves using an artificial transmission source in an exploration area; and a second step of performing, by a server, an inversion by applying a surface wave dispersion curve inversion technique to a frequency-phase velocity dispersion curve according to the passive elastic wave signal or the elastic wave signal containing the refracted wave.

Further, in the method for evaluating an urban ground stability using traffic noise according to the present invention, the second step includes generating, by an artificial synthetic model generation unit, horizontal 2-layer S-wave velocity model which is an artificial synthesis model by using a refraction method from an elastic wave signal containing a refracted wave, generating, by a dispersion curve generation unit, the frequency-phase velocity dispersion curve from the passive elastic wave signal or the S-wave velocity model, performing, by an inversion performing unit, an inversion by applying a surface wave dispersion curve inversion technique to the generated frequency-phase velocity dispersion curve, and verifying, by a verification unit, the accuracy of the surface wave dispersion curve inversion technique.

In addition, in the method for evaluating an urban ground stability using traffic noise according to the present invention, the dispersion curve generation unit generates a virtual common transmission source collection by applying the cross-coherence based seismic interferometry technique to the elastic wave signal including the passive elastic wave signal or the refracted wave.

In addition, in the method for evaluating an urban ground stability using traffic noise according to the present invention, the dispersion curve generation unit applies a phase-shift and stack technique to the generated virtual common transmission source collection to generate a frequency-phase velocity dispersion spectrum.

In addition, in the method for evaluating an urban ground stability using traffic noise according to the present invention, the dispersion curve generation unit generates a frequency-phase velocity dispersion curve for the inversion from the generated frequency-phase velocity dispersion spectrum through picking.

In addition, in the method for evaluating an urban ground stability using traffic noise according to the present invention, the verification unit compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

In addition, the method for evaluating an urban ground stability using traffic noise according to the present invention includes quantitatively analyzing, by an analysis unit, the accuracy of the inversion, and the analysis unit derives a correlation between the first inversion value and the second inversion value.

In addition, in the method for evaluating an urban ground stability using traffic noise according to the present invention, the surface wave dispersion curve inversion technique is a particle swarm optimization technique.

Specific details of other exemplary embodiments are included in “Details for carrying out the invention” and accompanying “drawings”.

Advantages and/or features of the present invention, and a method for achieving the advantages and/or features will become obvious with reference to various exemplary embodiments to be described below in detail together with the accompanying drawings.

However, the present invention is not limited only to a configuration of each exemplary embodiment disclosed below, but may also be implemented in various different forms. The respective exemplary embodiments disclosed in this specification are provided only to complete disclosure of the present invention and to fully provide those skilled in the art to which the present invention pertains with the category of the invention, and the present invention will be defined only by the scope of each claim of the claims.

According to the present invention, there is an effect of deriving a physical property (S wave velocity) according to a depth by performing an inversion for a surface wave dispersion curve generated by traffic vibration in order to more accurately derive an underground physical property value (S wave velocity).

Further, the physical property value (S wave velocity) generated according to the present invention can be used to provide geological information required for determining and responding to geological disaster factors such as sinkholes and soft ground.

On the other hand, according to the present invention, there is an effect in that the system and the method can be used to provide geological information required for safe design of buildings and smart city creation and management.

### BRIEF DESCRIPTION OF THE DRAWINGS

FIG. 1 is a block diagram illustrating an overall configuration of a system for evaluating an urban ground stability using traffic noise according to the present invention.

FIG. 2 is a block diagram illustrating a configuration of a server in the system for evaluating an urban ground stability using traffic noise according to the present invention.

FIG. 3 is a graph illustrating an S wave velocity model which is an artificial synthesis model in the system for evaluating an urban ground stability using traffic noise according to the present invention.

FIG. 4 illustrates a dispersion curve acquired for the S wave velocity model which is the artificial synthesis model in the system for evaluating an urban ground stability using traffic noise according to the present invention.

FIG. 5 is a graph in which the S wave velocity model which is the artificial synthesis model in the system for evaluating an urban ground stability using traffic noise according to the present invention is expressed as a black line, an S wave velocity derived by a simulated annealing technique is expressed as a blue line, and an S wave velocity derived by an inversion based on a particle swarm optimization technique is expressed as a red line.

FIG. 6 is a photograph showing an on-site elastic wave exploration sideline (red line) in downtown Pohang by the system for evaluating an urban ground stability using traffic noise according to the present invention.

FIG. 7 is a graph illustrating on-site elastic wave data acquired by the system for evaluating an urban ground stability using traffic noise according to the present invention.

FIG. 8 is a graph illustrating a virtual common transmission source collection by a cross-coherence technique by the system for evaluating an urban ground stability using traffic noise according to the present invention.

FIG. 9 is a graph illustrating a frequency-phase velocity dispersion spectrum derived after applying a phase-shift and stack technique to the virtual common transmission source collection acquired the system for evaluating an urban ground stability using traffic noise according to the present invention.

FIG. 10 is a graph illustrating a dispersion curve derived through picking from a cross-coherence based dispersion spectrum acquired by the system for evaluating an urban ground stability using traffic noise according to the present invention.

FIG. 11 is a graph illustrating seismic wave measurement data obtained through an artificial transmission source (hammer) to verify the accuracy of inversion results for on-site data in the system for evaluating invention.

FIG. 12 is a graph in which a two-layer S-wave velocity model derived from a refracted wave acquired by the system for evaluating an urban ground stability using traffic noise according to the present invention is expressed as a black dotted line, an S wave velocity derived by a simulated annealing technique based inversion for traffic noise on-site data is expressed as the red line, and an S wave velocity derived by the inversion based on the particle swarm optimization technique is expressed as the blue line.

FIG. 13 is a flowchart illustrating an overall flow of a method for evaluating an urban ground stability using traffic noise according to the present invention.

### DETAILED DESCRIPTION OF THE INVENTION

Before describing the present invention in detail, the terms or words used in this specification should not be construed as being unconditionally limited to their ordinary or dictionary meanings, and in order for the inventor of the present invention to describe his/her invention in the best way, concepts of various terms may be appropriately defined and used, and furthermore, the terms or words should be construed as means and concepts which are consistent with a technical idea of the present invention.

That is, the terms used in this specification are only used to describe preferred embodiments of the present invention, and are not used for the purpose of specifically limiting the contents of the present invention, and it should be noted that the terms are defined by considering various possibilities of the present invention.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but further includes any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side”, “other side”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present invention may be described while being partially exaggerated, reduced, or omitted for sufficiently clearly delivering the spirit of the present invention, and thus the proportion or scale may not be exact.

Further, hereinafter, in describing the present invention, a detailed description of a configuration determined that may unnecessarily obscure the subject matter of the present invention, for example, a detailed description of a known technology including the prior art may be omitted.

Hereinafter, exemplary embodiments of the present invention will be described in detail with reference to related drawings.

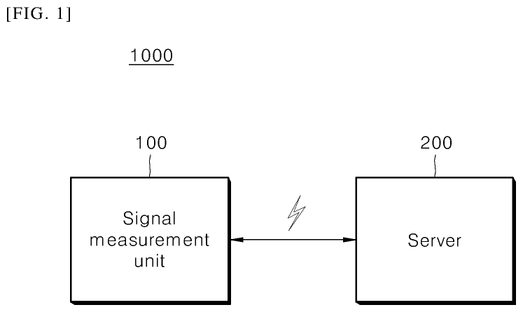

FIG. 1 is a block diagram illustrating an overall configuration of a system for evaluating an urban ground stability using traffic noise according to the present invention.

Referring to FIG. 1, the system 1000 for evaluating an urban ground stability using traffic noise according to the present invention includes a signal measurement unit 100 and a server 200.

The signal measurement unit 100 may measure a passive elastic wave signal generated by the traffic noise.

In addition, an elastic wave signal containing refracted waves may be acquired using an artificial transmission source in an exploration area.

Meanwhile, the server 200 performs an inversion by applying a surface wave dispersion curve inversion technique to a frequency-phase velocity dispersion curve according to the passive elastic wave signal or the elastic wave signal containing the refracted wave.

This will be described in more detail.

In the present invention, in order to derive accurate underground physical property values (S-wave velocity), a surface wave dispersion curve inversion technique based on particle swarm optimization which is a wide-area optimization technique is applied.

In the related art, the inversion of the surface wave dispersion curve is performed using a simulated annealing technique.

In other words, a concept of simulated annealing is that when an initial temperature is high, a physical property variable can randomly move within a wide range centered on a current position, and then as the temperature gradually decreases, the range within which the physical property variable can move randomly from the current position depends on the temperature.

Therefore, when the temperature is high, local minima may be avoided, and as the temperature decreases, a global minimum may be reached.

An actual physical property variable moves randomly with a probability of the probability distribution in Equation 1 below.

$$P ( Δ E ) = \frac{exp ( - Δ E / T )}{\sum exp ( - Δ E / T )} \qquad [ Equation 1 ]$$

Where ΔE represents a change amount of an objective function, and T represents the temperature.

The probability distribution is a bell-shaped exponential function, and the higher the temperature T, the wider the bell shape, and the lower the temperature, the narrower the bell shape.

In the present invention, the inversion is performed using a surface wave dispersion curve inversion technique.

In particular, instead of using the simulated annealing technique in the related art, the surface wave dispersion curve inversion technique based on the particle swarm optimization technique may be applied.

The inversion of the surface wave dispersion curve using the particle swarm optimization technique is performed as follows.

The particle swarm optimization technique randomly generates a large number of potential candidates for physical property variables.

Each candidate calculates a direction and a distance to be moved next, and moves by using a position of a candidate having a lowest objective function in an entire group (Best Position Of The Group), a lowest object function position of each candidate (Best Position Of The Particle), and a current search direction of each candidate (Search Direction Of The Particle).

Equation 2 below is an equation representing a direction and a distance vᵢ(t+1) to be moved next, and a position xᵢ(t+1) moved next using the same, and gᵢ(t) represents the position of the candidate having the lowest objective function in the entire group, pᵢ(t) represents the lowest objective function position of each candidate, xᵢ(t) represents the current position of each candidate, and vᵢ(t) represents the current search direction of each candidate.

vᵢ(t+1)=wvᵢ(t)+c₁(pᵢ(t)−xᵢ(t))+c₂(gᵢ(t)−xᵢ(t))

xᵢ(t+1)+xᵢ(t)+vᵢ(t+1) [Equation 2]

Where w, c₁, and c₂ adopt variables derived from many experiments and demonstrations, w represents a constant which linearly decreases from 0.9 to 0.2 when the number of inversion iterations increases, and c₁ and c₂ adopt a value of 2.

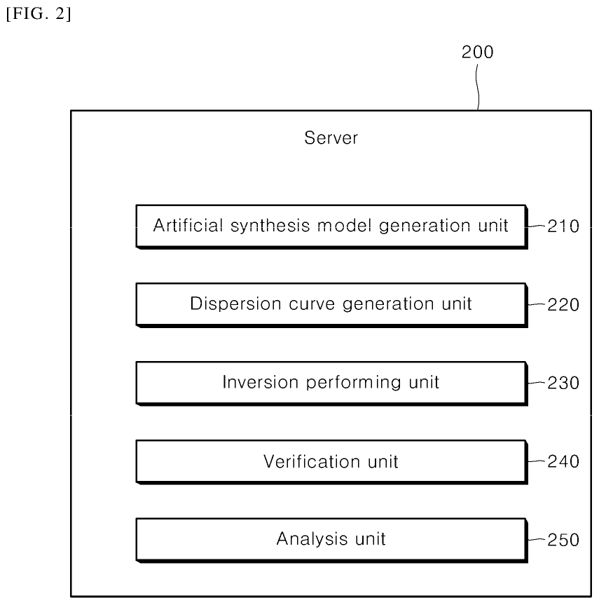

FIG. 2 is a block diagram illustrating a configuration of a server in the system for evaluating an urban ground stability using traffic noise according to the present invention.

Referring to FIG. 2, in the system 1000 for evaluating an urban ground stability using traffic noise according to the present invention, the server 200 includes an artificial synthesis model generation unit 210, a dispersion curve generation unit 220, an inversion performing unit 230, a verification unit 240, an analysis unit 250, etc.

The artificial synthesis model generation unit 210 generates a horizontal 2-layer S-wave velocity model which is an artificial synthesis model from an elastic wave signal containing a refracted wave by using a refraction method.

The dispersion curve generation unit 220 generates a frequency-phase velocity dispersion curve from a passive elastic wave signal or an S-wave velocity model.

The inversion performing unit 230 performs an inversion by applying a surface wave dispersion curve inversion technique to the generated frequency-phase velocity dispersion curve.

The verification unit 240 verifies the accuracy of the surface wave dispersion curve inversion technique.

The analysis unit 250 quantitatively analyzes the accuracy of the inversion.

In the present invention, the inversion is performed on on-site data according to actual traffic noise, and the inversion is performed on the artificial synthesis model, and then both inversion values are compared and verified to verify the accuracy of the on-site data according to the actual traffic noise.

First, the artificial synthesis model inversion will be described.

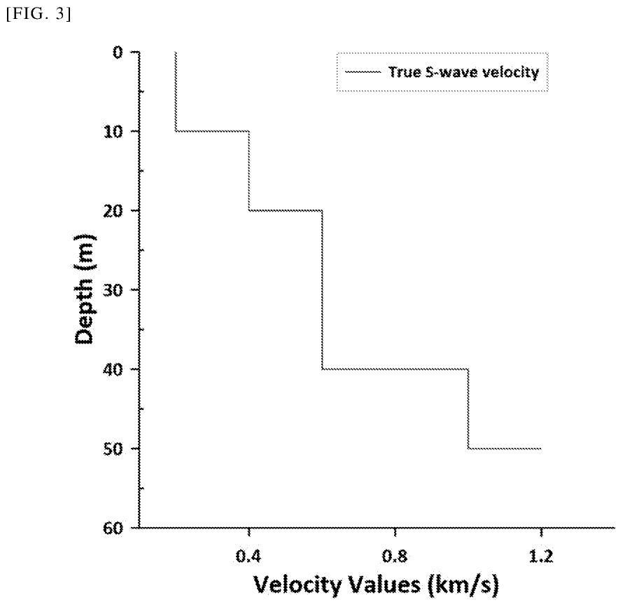

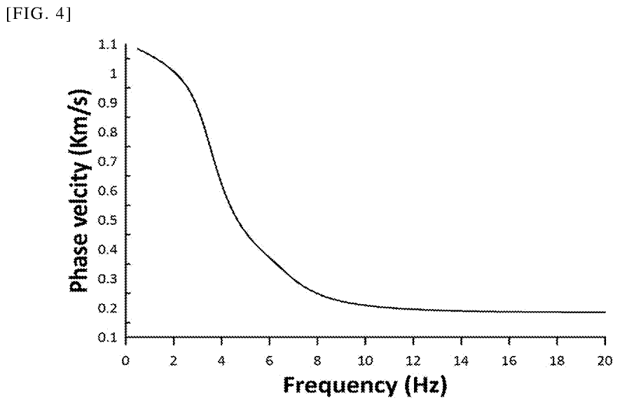

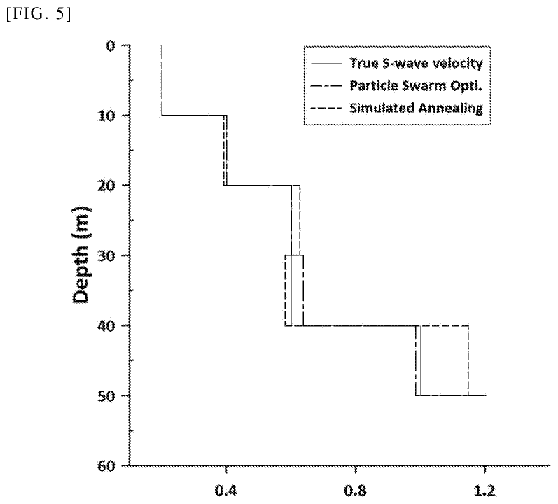

FIG. 3 is a graph illustrating an S wave velocity model which is an artificial synthesis model in the system for evaluating an urban ground stability using traffic noise according to the present invention, FIG. 4 illustrates a dispersion curve acquired for the S wave velocity model which is the artificial synthesis model in the system for evaluating an urban ground stability using traffic noise according to the present invention, and FIG. 5 is a graph in which the S wave velocity model which is the artificial synthesis model in the system for evaluating an urban ground stability using traffic noise according to the present invention is expressed as a black line, an S wave velocity derived by a simulated annealing technique is expressed as a blue line, and an S wave velocity derived by an inversion based on a particle swarm optimization technique is expressed as a red line.

Referring to FIGS. 3 to 5, in order to verify the accuracy of the surface wave dispersion curve inversion technique by the verification unit 240, a dispersion curve is created for the artificial synthesis model, and a result acquired by inverting the dispersion curve and a result acquired by inverting the on-site data according to the actual traffic noise are compared.

As illustrated in FIG. 3, the S-wave velocity model, which is the artificial synthesis model, is produced.

From this, the frequency-phase velocity dispersion curve illustrated in FIG. 4 is produced using the dispersion curve modeling technique.

As illustrated in FIG. 5, for the produced dispersion curve, the inversion value based on the actual traffic noise derived by applying the simulated annealing based inversion technique and the particle swarm optimization based inversion technique and the artificial synthesis model inversion value are compared.

Next, the inversion of actual traffic noise on-site data will be described.

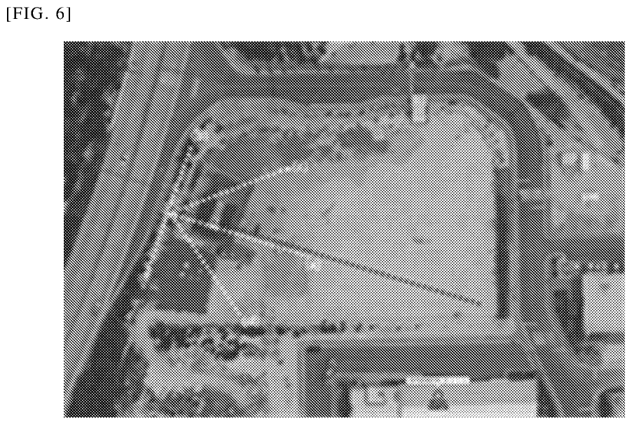

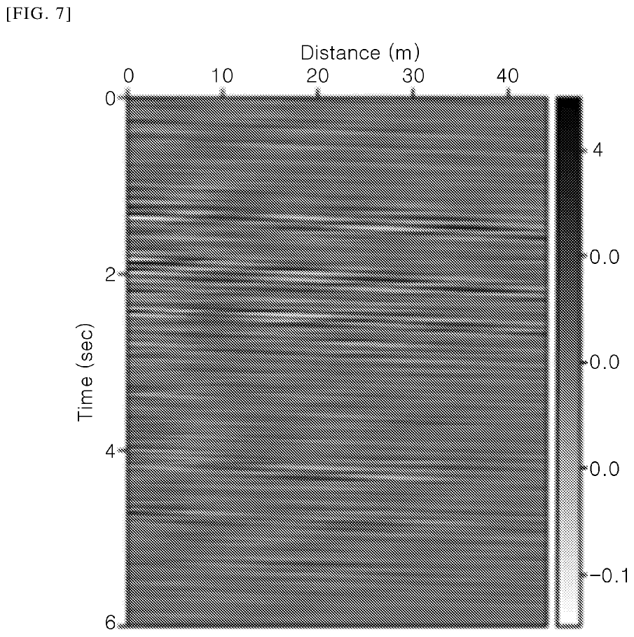

FIG. 6 is a photograph showing an on-site elastic wave exploration sideline (red line) in downtown Pohang by the system for evaluating an urban ground stability using traffic noise according to the present invention, and FIG. 7 is a graph illustrating on-site elastic wave data acquired by the system for evaluating an urban ground stability using traffic noise according to the present invention.

Referring to FIGS. 6 and 7, in order to verify the effectiveness of the dispersion curve inversion technique described above on the actual on-site elastic wave data, the passive elastic wave signal generated by the traffic noise in a downtown area (Pohang) is used.

The on-site passive elastic wave exploration sideline in the downtown Pohang is represented as the red line in FIG. 6, and on this sideline, 45 receivers are installed at 1 m intervals and traffic vehicle signals are measured.

FIG. 7 illustrates on-site elastic wave data in which traffic noise on a road is recorded for 6 seconds.

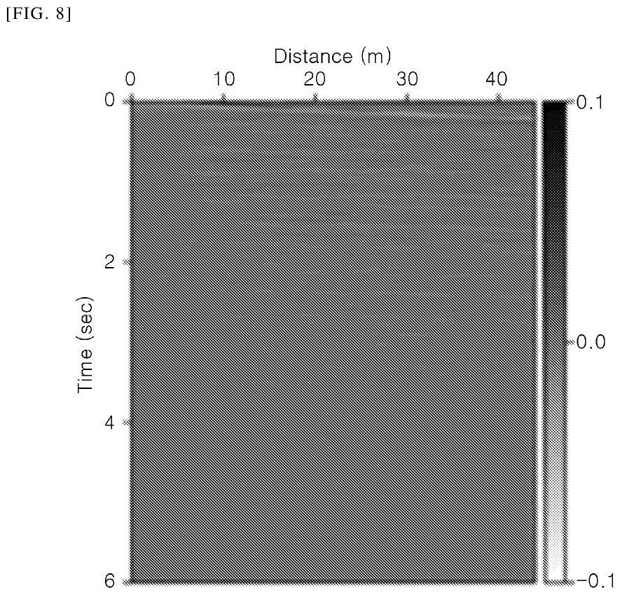

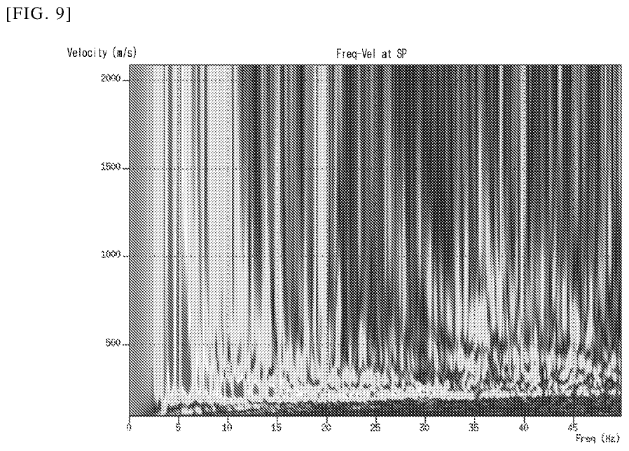

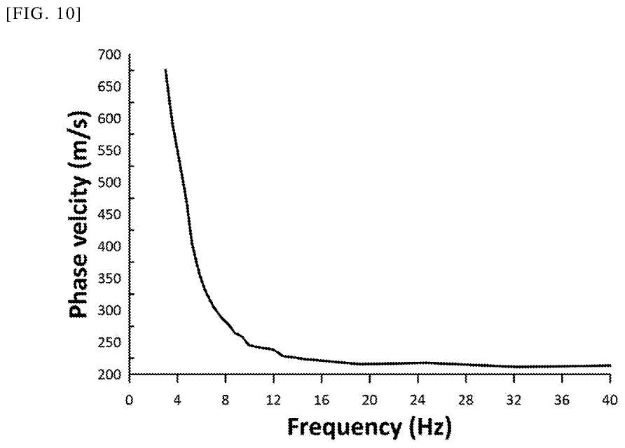

FIG. 8 is a graph illustrating a virtual common transmission source collection by a cross-coherence technique by the system for evaluating an urban ground stability using traffic noise according to the present invention, FIG. 9 is a graph illustrating a frequency-phase velocity dispersion spectrum derived after applying a phase-shift and stack technique to the virtual common transmission source collection acquired the system for evaluating an urban ground stability using traffic noise according to the present invention, and FIG. 10 is a graph illustrating a dispersion curve derived through picking from a cross-coherence based dispersion spectrum acquired by the system for evaluating an urban ground stability using traffic noise according to the present invention.

The description will be made with reference to FIGS. 8 to 10.

In order to perform an inversion of the dispersion curve for the on-site data, the dispersion curve used as input data must first be generated.

Because the on-site elastic wave data in FIG. 7 is not in the form of a point transmission source, the dispersion curve may not be directly generated from the on-site elastic wave data.

Therefore, in the present invention, the dispersion curve for the on-site data is generated through the following steps.

First, referring to FIG. 8, a seismic interferometry technique based on cross-coherence is applied to the on-site data (see FIG. 7) to generate a virtual common transmission source collection with low noise (see FIG. 8).

Here, the seismic interferometry technique is a technique that converts noise type data measured from traffic noise into point transmission source type data and determines underground physical properties from this, and the cross-coherence method is defined as a cross-correlation normalized as one of the seismic interferometry techniques, and generates the point transmission source type data from this to determine the underground physical properties.

That is, in the system 1000 for evaluating an urban ground stability using traffic noise according to the present invention, the dispersion curve generation unit 220 generates the virtual common transmission source collection by applying the cross-coherence based seismic interferometry technique to the passive elastic wave signal or the elastic wave signal containing the refracted wave.

In particular, the virtual common transmission source collection is generated by applying the cross-coherence based seismic interferometry technique to the passive elastic wave signal.

Next, referring to FIG. 9, the phase-shift and stack technique is applied to the virtual common transmission source collection (see FIG. 8) to generate a frequency-phase velocity dispersion spectrum (see FIG. 9).

That is, in the system 1000 for evaluating an urban ground stability using traffic noise according to the present invention, the dispersion curve generation unit 220 applies the phase-shift and stack technique to the generated virtual common transmission source collection to generate the frequency-phase velocity dispersion spectrum.

Here, the phase shift and stack technique is a technique that derives the frequency-phase velocity dispersion spectrum.

Referring to FIG. 10, the dispersion curve for the inversion is derived from the dispersion spectrum through picking.

That is, in the system 1000 for evaluating an urban ground stability using traffic noise according to the present invention, the dispersion curve generation unit 220 generates the frequency-phase velocity dispersion curve for the inversion from the generated frequency-phase velocity dispersion spectrum through picking.

Since low-frequency (4 Hz or less) information is absent in the dispersion curve, there is a limit in inversion of physical property information of a large depth, so it is efficient to performs the inversion after previously determining a maximum invertable depth by considering calculation efficiency.

The maximum inversion depth is possible up to approximately ⅓ of a wavelength, and the wavelength is calculated by using Equation 3 below.

λ=υₚₕ/f [Equation 3]

Where λ represents the wavelength, υₚₕ represents a phase velocity, and f represents a frequency.

In the present invention, the dispersion curve (see FIG. 10) has a phase velocity value of approximately 0.6 km/s at the frequency of 4 Hz, and when a wavelength for a variable value is calculated, the wavelength becomes approximately 150 m.

The maximum inversion depth is approximately 50 m which is approximately ⅓ of the wavelength, so only a physical property value up to a depth of 50 m is calculated at the time of performing the dispersion curve inversion.

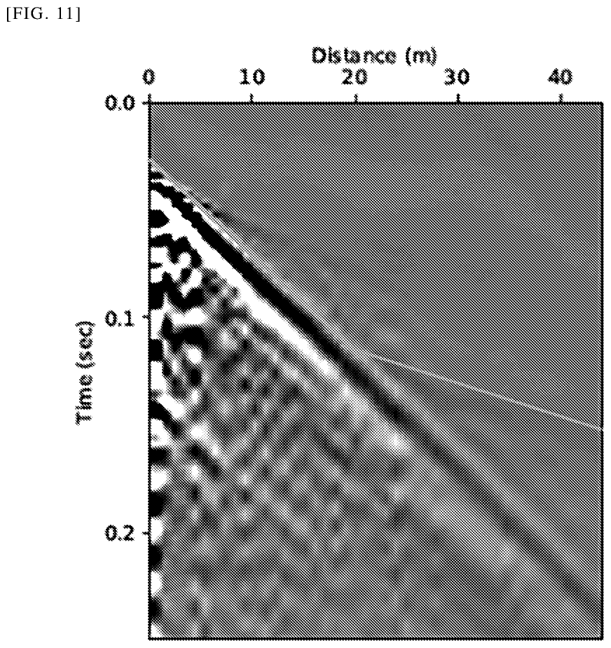

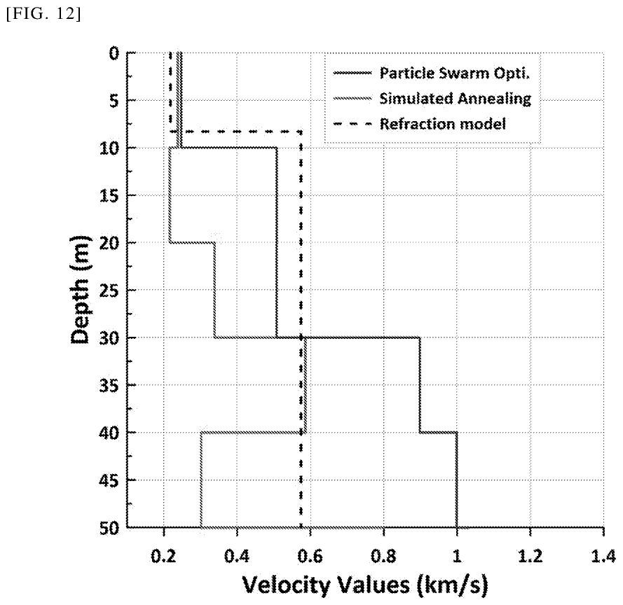

FIG. 11 is a graph illustrating seismic wave measurement data obtained through an artificial transmission source (hammer) to verify the accuracy of inversion results for on-site data in the system for evaluating an urban ground stability using traffic noise according to the present invention, and FIG. 12 is a graph in which a two-layer S-wave velocity model derived from a refracted wave acquired by the system for evaluating an urban ground stability using traffic noise according to the present invention is expressed as a black dotted line, an S wave velocity derived by a simulated annealing technique based inversion for traffic noise on-site data is expressed as the red line, and an S wave velocity derived by the inversion based on the particle swarm optimization technique is expressed as the blue line.

Referring to FIGS. 11 and 12, in order to verify the accuracy of the inversion results for the traffic noise on-site data, elastic wave data containing refracted waves (FIG. 11) is additionally acquired by using the artificial transmission source (e.g., hammer), and a horizontal 2-layer S-wave velocity model (the black line of FIG. 12) is generated from the data by using a refraction method.

The refraction method exploration is an exploration technique that derives a depth and a velocity of a subsurface.

It can be seen that a one-layer S-wave velocity is approximately 218 m/s, a thickness is approximately 8.3 m, and the two-layer S-wave velocity is approximately 574 m/s.

The simulated annealing based inversion technique and the particle swarm optimization technique are applied to the dispersion curve (see FIG. 10) for the traffic noise on-site data, so it can be seen that the derived S-wave velocities are expressed as the red line and the blue line, respectively in FIG. 12.

Upon the inversion, the velocity model is constituted by 6 layers, and a thickness of each layer is fixed to 10 m.

A velocity of a first layer of S-wave results for the traffic noise on-site data derived by the simulated annealing based inversion technique and the particle swarm optimization based inversion technique appears close to the velocity derived by the refraction method.

However, a velocity of a second layer in a particle swarm optimization based inversion result is derived similarly to a refraction method velocity as compared with a simulated annealing based inversion result.

Additionally, in order to quantitatively analyze the accuracy of the inversion result, each correlation (normalized zero-lag cross-correlation) between a result acquired by inverting the traffic noise on-site data and a result acquired by inverting the artificial synthesis model is calculated.

As a result, it can be seen that the correlation of the simulated annealing inversion technique is approximately 93.03%, while the correlation of the particle swarm optimization inversion technique is approximately 94.88%.

From the result, it may be quantitatively determined that the particle swarm optimization inversion technique according to the present invention derives physical property values that are closer to the S-wave velocity by the artificial synthesis model derived by the refraction method compared to the simulated annealing inversion technique.

Therefore, it may be verified that it is more reasonable to apply the particle swarm optimization-based inversion technique rather than the simulated annealing-based inversion technique in order to derive an accurate physical property value (S-wave velocity) of the urban underground from the on-site elastic wave data acquired from the traffic noise.

In other words, in the system 1000 for evaluating an urban ground stability using traffic noise according to the present invention, the verification unit 240 compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

As a result of this verification, it can be confirmed that the surface wave dispersion curve inversion technique based on the particle swarm optimization technique derives the physical property value that is closer to the S-wave velocity by the artificial synthesis model than the simulated annealing technique in the related art.

Therefore, in the system 1000 for evaluating an urban ground stability using traffic noise according to the present invention, the surface wave dispersion curve inversion technique may adopt the particle swarm optimization technique.

Meanwhile, the analysis unit 250 derives a correlation between the first inversion value and the second inversion value.

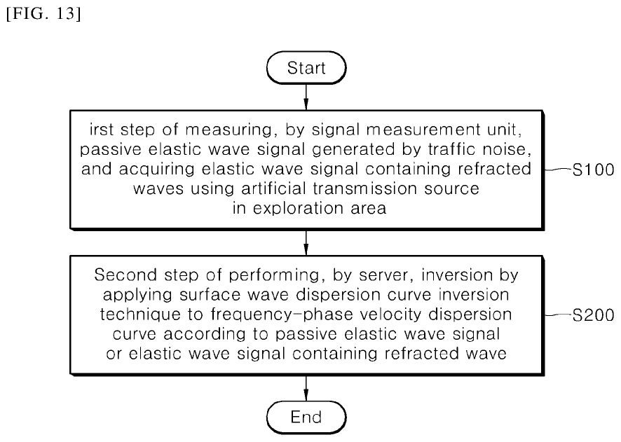

FIG. 13 is a flowchart illustrating an overall flow of a method for evaluating an urban ground stability using traffic noise according to the present invention.

Components of each system applied to the method for evaluating invention are the same as the components of the system for evaluating an urban ground stability using traffic noise according to the present invention, so a detailed description thereof will be omitted.

The method for evaluating an urban ground stability using traffic noise according to the present invention may include two steps.

In a first step S100, a signal measurement unit 100 may measure a passive elastic wave signal generated by traffic noise, and acquire an elastic wave signal including a refracted wave by using an artificial transmission source in an exploration area.

In a second step S200, a server 200 may perform an inversion by applying a surface wave dispersion curve inversion technique to a frequency-phase velocity dispersion curve according to the passive elastic wave signal or the elastic wave signal containing the refracted wave.

Here, the second step S200 may further include four steps.

That is, the method may further include a step of generating, by an artificial synthetic model generation unit 210, a horizontal 2-layer S-wave velocity model which is an artificial synthesis model from an elastic wave signal containing a refracted wave by using a refraction method.

Further, the method may further include a step of generating, by a dispersion curve generation unit 220, a frequency-phase velocity dispersion curve from a passive elastic wave signal or an S-wave velocity model.

Further, the method may further include, a step of by performing, by an inversion performing unit 230, an inversion by applying a surface wave dispersion curve inversion technique to the generated frequency-phase velocity dispersion curve.

Further, the method may further include a step of verifying, by a verification unit 240, the accuracy of the surface wave dispersion curve inversion technique.

Here, in order to perform an inversion of the dispersion curve for the on-site data, the dispersion curve used as input data must first be generated.

Because the on-site elastic wave data is not in the form of a point transmission source, the dispersion curve may not be directly generated from the on-site elastic wave data.

Therefore, in the present invention, the dispersion curve for the on-site data is generated through the following steps.

The dispersion curve generation unit 220 generates a virtual common transmission source collection by applying the cross-coherence based seismic interferometry technique to the elastic wave signal including the passive elastic wave signal or the refracted wave.

Next, the dispersion curve generation unit 220 applies a phase-shift and stack technique to the generated virtual common transmission source collection to generate a frequency-phase velocity dispersion spectrum.

Next, the dispersion curve generation unit 220 generates a frequency-phase velocity dispersion curve for the inversion from the generated frequency-phase velocity dispersion spectrum through picking.

Thereafter, in the method for evaluating an urban ground stability using traffic noise according to the present invention, the verification unit 240 compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

Meanwhile, the method for evaluating an urban ground stability using traffic noise according to the present invention may further include a step of quantitatively analyzing, an analysis unit 250, the accuracy of the inversion.

The analysis unit 250 derives a correlation between a first inversion value and a second inversion value.

Therefore, the method for evaluating an urban ground stability using traffic noise according to the present invention, the surface wave dispersion curve inversion technique adopts the particle swarm optimization technique rather than the simulated annealing technique in the related art.

Disasters caused by sinkholes and soft ground occur frequently in urban areas, and it is necessary to establish underground physical property information (S-wave velocity) in the urban area to preemptively respond to and prevent such disasters.

In the present invention, in order to efficiently establish the underground physical property information (S-wave velocity) in the urban areas without enormous costs, underground physical property data (S-wave velocity) are derived from traffic noise signals.

As such, according to the present invention, there is an effect of deriving a physical property (S wave velocity) according to a depth by performing an inversion for a surface wave dispersion curve generated by traffic vibration in order to more accurately derive an underground physical property value (S wave velocity).

Further, the physical property value (S wave velocity) generated according to the present invention can be used to provide geological information required for determining and responding to geological disaster factors such as sinkholes and soft ground.

On the other hand, according to the present invention, there is an effect in that the system and the method can be used to provide geological information required for safe design of buildings and smart city creation and management.

In the above, although several preferred embodiments of the present invention have been described with some examples, the descriptions of various exemplary embodiments described in the “Specific Content for Carrying Out the Invention” item are merely exemplary, and it will be appreciated by those skilled in the art that the present invention can be variously modified and carried out or equivalent executions to the present invention can be performed from the above description.

In addition, since the present invention can be implemented in various other forms, the present invention is not limited by the above description, and the above description is for the purpose of completing the disclosure of the present invention, and the above description is just provided to completely inform those skilled in the art of the scope of the present invention, and it should be known that the present invention is only defined by each of the claims.

What is claimed is:

1. A system for evaluating an urban ground stability using traffic noise, the system comprising:
a signal measurement unit measuring a passive elastic wave signal generated by the traffic noise, and acquiring an elastic wave signal containing refracted waves using an artificial transmission source in an exploration area; and
a server performing an inversion by applying a surface wave dispersion curve inversion technique to a frequency-phase velocity dispersion curve according to the passive elastic wave signal or the elastic wave signal containing the refracted wave.

2. The system of claim 1, wherein the server includes
an artificial synthetic model generation unit generating a horizontal 2-layer S-wave velocity model which is an artificial synthesis model from the elastic wave signal containing the refracted wave by using a refraction method,
a dispersion curve generation unit generating the frequency-phase velocity dispersion curve from the passive elastic wave signal or the S-wave velocity model,
an inversion performing unit performing an inversion by applying a surface wave dispersion curve inversion technique to the generated frequency-phase velocity dispersion curve, and
a verification unit verifying the accuracy of the surface wave dispersion curve inversion technique.

3. The system of claim 2, wherein the dispersion curve generation unit generates a virtual common transmission source collection by applying the cross-coherence based seismic interferometry technique to the elastic wave signal including the passive elastic wave signal or the refracted wave.

4. The system of claim 3, wherein the dispersion curve generation unit applies a phase-shift and stack technique to the generated virtual common transmission source collection to generate a frequency-phase velocity dispersion spectrum.

5. The system of claim 4, wherein the dispersion curve generation unit generates a frequency-phase velocity dispersion curve for the inversion from the generated frequency-phase velocity dispersion spectrum through picking.

6. The system of claim 2, wherein the verification unit compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

7. The system of claim 6, comprising:
an analysis unit quantitatively analyzing the accuracy of the inversion,
wherein the analysis unit derives a correlation between the first inversion value and the second inversion value.

8. The system of claim 1, wherein the surface wave dispersion curve inversion technique is a particle swarm optimization technique.

9. A method for evaluating an urban ground stability using traffic noise, the method comprising:
a first step of measuring, by a signal measurement unit, a passive elastic wave signal generated by the traffic noise, and acquiring an elastic wave signal containing refracted waves using an artificial transmission source in an exploration area; and
a second step of performing, by a server, an inversion by applying a surface wave dispersion curve inversion technique to a frequency-phase velocity dispersion curve according to the passive elastic wave signal or the elastic wave signal containing the refracted wave.

10. The method of claim 9, wherein the second step includes
generating, by an artificial synthetic model generation unit, horizontal 2-layer S-wave velocity model which is an artificial synthesis model by using a refraction method from an elastic wave signal containing a refracted wave,
generating, by a dispersion curve generation unit, the frequency-phase velocity dispersion curve from the passive elastic wave signal or the S-wave velocity model,
performing, by an inversion performing unit, an inversion by applying a surface wave dispersion curve inversion technique to the generated frequency-phase velocity dispersion curve, and
verifying, by a verification unit, the accuracy of the surface wave dispersion curve inversion technique.

11. The method of claim 10, wherein the dispersion curve generation unit generates a virtual common transmission source collection by applying the cross-coherence based seismic interferometry technique to the elastic wave signal including the passive elastic wave signal or the refracted wave.

12. The method of claim 11, wherein the dispersion curve generation unit applies a phase-shift and stack technique to the generated virtual common transmission source collection to generate a frequency-phase velocity dispersion spectrum.

13. The method of claim 12, wherein the dispersion curve generation unit generates a frequency-phase velocity dispersion curve for the inversion from the generated frequency-phase velocity dispersion spectrum through picking.

14. The method of claim 10, wherein the verification unit compares and verifies a first inversion value acquired by applying the surface wave dispersion curve inversion technique to a first frequency-phase velocity dispersion curve generated by the passive elastic wave signal, and a second inversion value acquired by applying the surface wave dispersion curve inversion technique to a second frequency-phase velocity dispersion curve generated by the S-wave velocity model.

15. The method of claim 14, comprising:
quantitatively analyzing, by an analysis unit, the accuracy of the inversion,
wherein the analysis unit derives a correlation between the first inversion value and the second inversion value.

16. The method of claim 9, wherein the surface wave dispersion curve inversion technique is a particle swarm optimization technique.
